(19) United States
(12) Patent Application Publication
(10) Pub. No.: US 2019/0164171 A1
(43) Pub. Date: May 30, 2019

(54) COMPUTING DIMENSIONAL INFLUENCE AND HEALTH SCORES IN NON-LINEAR STATISTICAL MODELS

(71) Applicant: salesforce.com, inc., San Francisco, CA (US)

(72) Inventors: Srivatsan RAMANUJAM, San Carlos, CA (US); Tye L. RATTENBURY, San Francisco, CA (US); Sree Krishna KUMARASWAMY, Mountain View, CA (US); Chaitanya Deepak KONDAPATURI, San Francisco, CA (US)

(21) Appl. No.: 15/828,140

(22) Filed: Nov. 30, 2017

(51) Int. Cl. G06Q 30/00; G06Q 10/04; G06F 17/18

(52) U.S. Cl. CPC G06Q 30/016; G06F 17/18; G06Q 10/04

(57) ABSTRACT

A method for determining the influence of attributes on a predicted outcome for a customer is described. The method includes computing for each dimension a score based on multiple applications of a non-linear statistical model on different combinations of other pieces of data with attribute values for the customer in that dimension, wherein each attribute was categorized into one of the plurality of dimensions based on a common characteristic for that dimension, wherein each dimension in the plurality of dimensions includes two or more of the attributes and attributes in each dimension share the common characteristic for that dimension, wherein each of the other pieces of data for each of the plurality of dimensions are attribute values independent of the dimension and the customer, wherein the first score for the customer for each of the plurality of dimensions indicates the influence of that dimension on the predicted outcome.

### TECHNICAL FIELD

One or more implementations relate to the computation of predicted outcomes using non-linear statistical models applied to a plurality of input attributes; and more specifically, to the computation of ‘influence’ and ‘health’ scores for input dimensions, composed of a subset of the plurality of input attributes, used as explanatory guides in the application of predicted outcomes in domains like customer relationship management.

### BACKGROUND

Across a plurality of domains, including customer relationship management, statistical models are built and used to estimate the probability of an outcome, such as future purchasing behavior of a current customer. The statistical model may have been built upon historical knowledge of other customers or using historical data about the same customer at a different time in the past. For these customers, their past outcomes and associated attribute values are already known. For example, it may be known that customer A grew their relationship with company B (i.e., their outcome) two years ago and during that time customer A may be associated with a particular set of attribute values (e.g., customer A may have had one-hundred employees, three offices, purchased 400 individual licenses of a product from customer B, etc.). This historical knowledge of customer A may be used to build the statistical model. For a current customer, a predicted outcome of the customer may be determined based on inputting known, current attribute values for this customer into the statistical model. For example, a statistical model may be used by a customer service manager at a company to estimate the probability that the current customer will grow or attrit (e.g., reduce or make smaller) their relationship with the company (this probability indicating the likelihood of the predicted outcome).

Although a predicted outcome for a customer may be useful to the customer service manager, whose task is to maintain or grow the relationship with the customer, the prediction may be too opaque to provide much actionable data. Namely, predicting that a customer will fully attrit their relationship with a company does not indicate why the customer is predicted to take such an action or what can be done to reduce the probability of such an outcome. Instead, the customer service manager is forced to examine all the attribute values associated with the customer to determine which attribute value(s) should be focused on to alter the predicted outcome of full attrition. Since there may be hundreds or thousands of attribute values for the customer used in the prediction, examining each attribute value is not an efficient solution.

Although described above in relation to business-to-business customer relationship management, the above concepts and issues may similarly apply to other domains in which statistical models are used to generate predicted outcomes. For example, other domains in which statistical models may be used to generate predicted outcomes include stock price predictions, insurance event predictions (e.g., home, automobile, health, etc.), user action predictions within a user interface, political election predictions, device failure predictions, business-to-consumer behavior predictions, and business-to-business predictions other than or in addition to the business-to-business customer relationship management described above.

### BRIEF DESCRIPTION OF THE DRAWINGS

The following figures use like reference numbers to refer to like elements. Although the following figures depict various exemplary implementations, alternative implementations are within the spirit and scope of the appended claims. In the drawings:

FIG. 1 shows a customer relationship management system according to one example implementation.

FIG. 2 shows a method for computing dimensional influence scores according to one example implementation.

FIG. 3A shows categorization of attributes into dimensions according to one example implementation.

FIG. 3B shows the combination of multiple dimensions to form another dimension according to one example implementation.

FIG. 4 shows a customer relationship management service receiving attribute values for one or more customers according to one example implementation.

FIG. 5 shows computation of probabilities of a plurality of possible outcomes and selection of a possible outcome as a predicted outcome for a customer according to one example implementation.

FIG. 6 shows generation of two modified sets of attribute values according to one example implementation.

FIG. 7 shows computing probabilities of possible outcomes in relation to two modified sets of attribute values and selecting a predicted outcome for each of the two modified sets of attribute values based on the probabilities according to one example implementation.

FIG. 8 shows selected probabilities in relation to two modified sets of attribute values according to one example implementation.

FIG. 9 shows generating a mean of selected according to one example implementation.

FIG. 10 shows a method for computing dimensional health scores according to one example implementation.

FIG. 11 shows computation of probabilities for a best possible outcome and a worst possible outcome in relation to both the modified sets of attribute values according to one example implementation.

FIG. 12 shows calculation according to one example implementation of the mean probability for the probabilities computed in relation to the modified sets of attribute values for the best possible outcome and the mean probability for the probabilities computed in relation to the modified sets of attribute values for the worst possible outcome.

FIG. 13 shows a dimensional health score for a dimension of a customer using multiple components according to one example implementation.

FIG. 14 shows conversion from multiple component dimensional health scores to single component dimensional health scores according to one example implementation.

FIG. 15A illustrates an electronic device according to one example implementation.

FIG. 15B shows a block diagram of an environment where an on-demand customer relationship management system may be implemented according to one example implementation.

### DETAILED DESCRIPTION

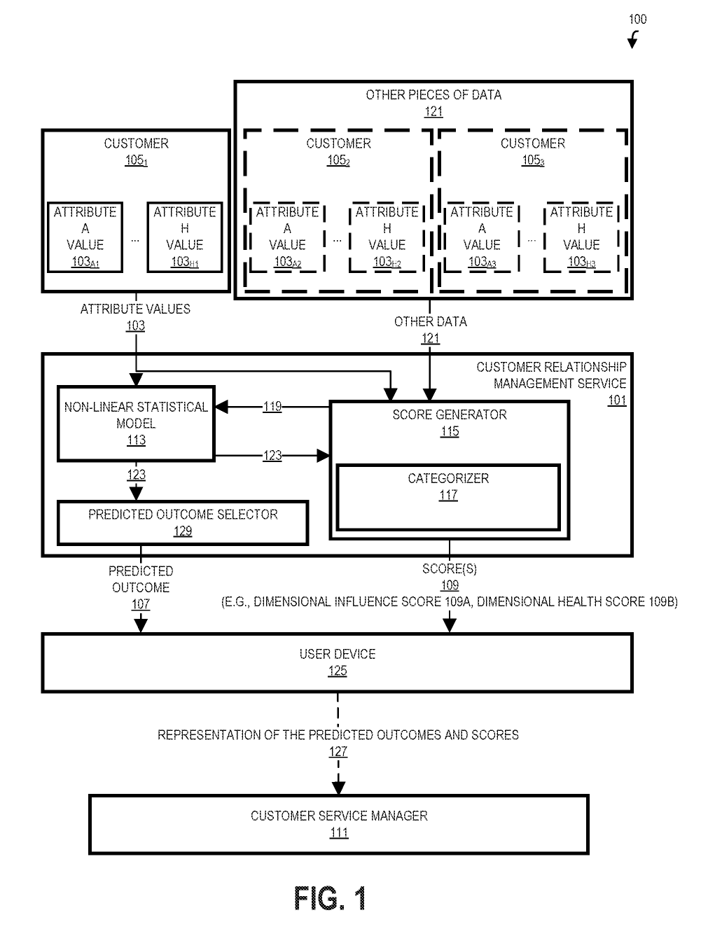

FIG. 1 shows a customer relationship management system 100 according to one example implementation. As shown, the customer relationship management system 100 may include a customer relationship management service 101 that receives attribute values 103, corresponding to attributes, for customer 105₁ and selects a predicted outcome 107 for the customer 105₁ and computes scores 109 associated with the predicted outcome 107 based on the attribute values 103 and other pieces of data 121. The predicted outcome 107 and scores 109 may be used by a customer service manager 111 (or other roles in an associated company/organization, including renewal managers, members of sales teams, member of marketing/program teams, and executives) for determining courses of action in relation to the customer 105₁ (e.g., increasing support for customer 105₁, reducing prices for customer 105₁, or taking no action towards the customer 105₁). For instance, in one iteration, the customer relationship management service 101 may: 1) select a single predicted outcome 107 for customer 105₁ based on all of the attribute values 103 of the customer 105₁; and 2) compute one or more scores 109 for each of a number of dimensions, where the dimensions are groupings of attributes for which the attribute values 103 were provided, and where the one or more scores 109 per dimension reflects something about that dimension of attribute values 103 relative to the single predicted outcome 107.

As used herein, a predicted outcome 107 is a prediction (sometimes referred to as a forecast) of the customer's 105₁ relationship with a company that the customer service manager 111 represents (e.g., the customer service manager 111 is an employee of the company with which the customer 105₁ has a relationship). For example, a predicted outcome 107 may be selected from a plurality of possible outcomes, including a customer 105 growing a relationship with a company (increase in product/service spending), a customer 105 retaining their previous relationship with a company (no net increase or decrease in product/service spending), a customer 105 partially attriting a relationship with a company (partial decrease in product/service spending), and a customer 105 fully attriting a relationship with a company (canceling/not renewing product/service subscription altogether). In some implementations, a predicted outcome 107 of the customer 105₁ may be selected using a non-linear statistical model 113 and a predicted outcome selector 129 of the customer relationship management service 101 based on the attribute values 103 of the customer 105₁. As used herein, a non-linear statistical model is a statistical model that is not linear in the parameters of the model. The outcome for such a model, may not be a simple product of the parameter values with the corresponding attribute values. For example, instead of applying scalar weights to each attribute value 103 to arrive at probabilities 123 of possible outcomes (from which the predicted outcome 107 may be selected), the non-linear statistical model 113 may use more complex functions of the attribute values 103 (e.g., exponential, logarithmic, power, and Gaussian functions) to arrive at probabilities 123 of possible outcomes. A non-linear model could also be expressed as a series of condition checks applied to attribute values to arrive at an outcome. This allows for more complex relationships to be described between attribute values and possible outcomes by non-linear statistical models in comparison to linear statistical models. In some implementations, the non-linear statistical model 113 may be a multiple class model that generates probabilities for each class. For example, the multiple classes may be the plurality of possible outcomes and the non-linear statistical model 113 generates probabilities 123 of each of these possible outcomes (e.g., a likelihood of the possible outcome occurring). In this example, the possible outcome in the plurality of possible outcomes with the highest probability 123 may be selected as the predicted outcome 107 by the predicted outcome selector 129.

Although FIG. 1 and the description herein is presented in the context of customer relationship management, the methods, systems, and devices described herein may be equally applied to other domains that involve selecting predicted outcomes for respective entities based on attributes of those entities input into a statistical model. For example, other domains in which statistical models may be used to generate predicted outcomes include stock price predictions, insurance event predictions (e.g., home, automobile, health, etc.), user action predictions within a user interface, political election predictions, device failure predictions, business-to-consumer behavior predictions, and business-to-business predictions other than or in addition to the business-to-business customer relationship management described above. In these diverse domains, predicted outcomes for customers may be replaced with predicted outcomes for entities, the customer relationship management service 101 may be replaced with an entity management service, and the customer relationship management system 100 may be replaced with an entity management system. As used herein, an entity may be an individual, an organization, a physical or conceptual object, or any other similar construct that may be described by attributes and for which a prediction or forecast of a future state or action may be generated.

As noted above, in addition to a predicted outcome 107, the customer relationship management service 101 computes score(s) 109 associated with the predicted outcome 107 using the score generator 115. In these implementations, attributes, corresponding to the attribute values 103, are categorized into dimensions using the categorizer 117 such that each dimension includes a plurality of attributes and each attribute in a dimension shares at least one common characteristic. For example, one of the dimensions may be related to customer engagement and each attribute in that dimension is related to the amount a customer engages with the company (e.g., how often the customer 105₁ contacts the customer service manager 111, how often the customer 105₁ contacts customer support provided by the company, etc.). Based on these dimensions, the score generator 115 computes scores 109 for each dimension of attribute values 103 of the customer 105₁ and relative to the predicted outcome 107 of the customer 105₁.

In some implementations, computation of a score(s) 109 for a given dimension of attribute values 103 of the customer 105₁ may be performed using the same non-linear statistical model 113 and modified sets of attribute values 119. In some such implementations, the modified sets of attribute values 119 used to compute a score(s) 109 for a given one of the dimensions may include the attribute values 103 of the customer 105₁ for the given dimension for which the score 109 is being computed and other pieces of data 121. In one implementation, these other pieces of data 121 are attribute values 103 of other customers 105 for other dimensions than the given dimension for which the score(s) 109 is being computed. Using the modified set of attribute values 119, the non-linear statistical model 113 may compute for the given dimension one or more probabilities 123 of possible outcomes. The one or more probabilities 123 of possible outcomes are passed to the score generator 115 such that the score generator 115 may compute the score(s) 109 for that dimension. In other words, in some implementations, for each of the dimensions, the score generator 115 generates a modified set of attribute values 119 (e.g., based on the dimensions, some of the attribute values 103 from customer 105₁ and some of the attribute values from other customers 105—such as customer 105₂ and customer 105₃), provides the modified set of attribute values 119 to the non-linear statistical model 113, receives back probabilities 123 of possible outcomes, and computes a score(s) 109 for that dimension relative to the predicted outcome 107 of the customer 105₁. While FIG. 1 illustrates customer 105₂ and customer 105₃ for exemplary purposes, it is understood that there may be more customers 105 for which the other pieces of data 121 is provided. Also, in some implementations, the customer relationship management service 101 may also compute predicted outcomes 107 and/or scores 109 for customers 105 other than customer 105₁ (e.g., customer 105₂ and/or customer 105₃)

The scores 109 computed by the score generator 115 may include a dimensional influence score 109A and optionally a dimensional health score 109B. A dimensional influence score 109A indicates the collective influence of attribute values 103 in that dimension on the predicted outcome 107 of the customer 105₁. A dimensional health score 109B indicates the collective health of attribute values 103 in the dimension for possible improvement. For example, the predicted outcome 107 of the customer 105₁ may indicate partial attrition with a company. A dimensional influence score 109A may indicate that a first dimension is very influential in this partial attrition predicted outcome 107. Although the first dimension is influential, a dimensional health score 109B may indicate that the first dimension is healthy and there is little room for improvement. Thus, a customer service manager 111 may choose not to focus on attribute values 103 in the first dimension of the customer 105₁ even though the first dimension is very influential in the partial attrition predicted outcome 107, because the attribute values 103 of the first dimension of the customer 105₁ has little room for improvement. Instead, the customer service manager 111 may focus on the attribute values 103 of a second dimension that is still influential and has more room for improvement.

The customer relationship management system 100 may also include a user device 125 that receives the predicted outcome 107 and the score(s) 109 and causes the presentation on a display of a representation 127 of the predicted outcome 109 and the score(s) 109 to a customer service manager 111 to instruct the customer service manager 111 to determine courses of action in relation to the customer 105₁.

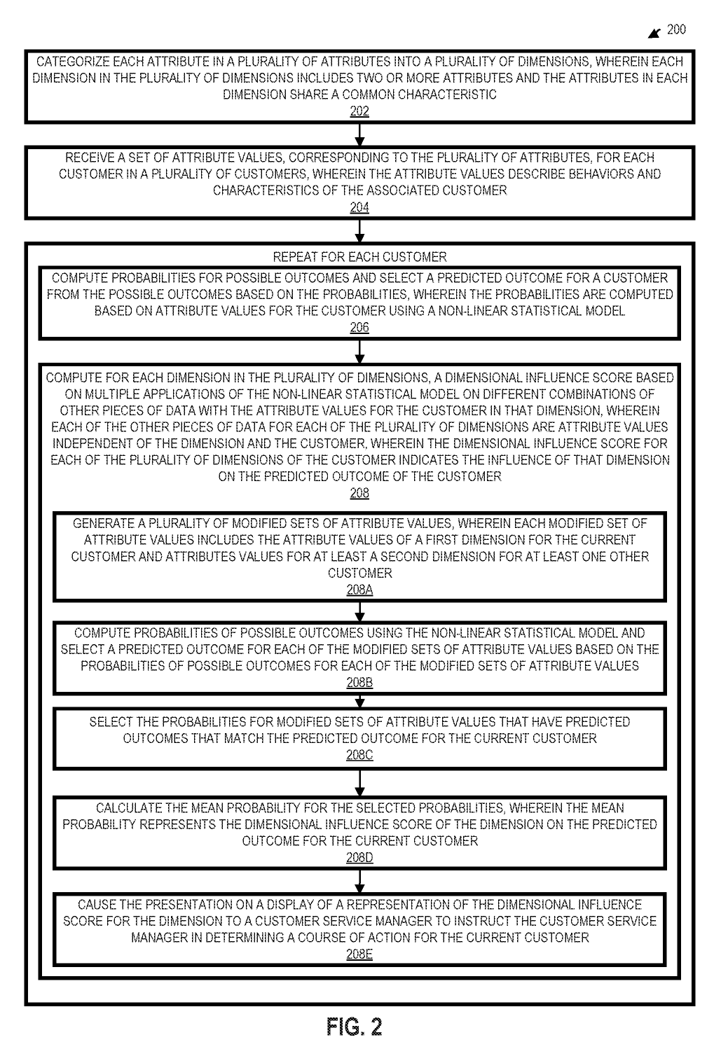

Each element of the customer relationship management system 100 will first be described in relation to a method 200 for computing dimensional influence scores 109A according to one example implementation as shown in FIG. 2. The operations in the flow diagram of FIG. 2 will be described with reference to the exemplary implementations of the other figures. However, it should be understood that the operations of the flow diagram can be performed by implementations other than those discussed with reference to the other figures, and the implementations discussed with reference to these other figures can perform operations different than those discussed with reference to the flow diagrams. Although described and shown in FIG. 2 in a particular order, the operations of the method 200 are not restricted to this order. For example, one or more of the operations of the method 200 may be performed in a different order or in partially or fully overlapping time periods. Accordingly, the description and depiction of the method 200 is for illustrative purposes and is not intended to restrict to a particular implementation.

In some implementations, one or more of the operations of the method 200 may be performed by components of the customer relationship management system 100. For example, one or more of the operations of the method 200 may be performed by the customer relationship management service 101 and the user device 125. In particular, the non-linear statistical model 113, the score generator 115, and the predicted outcome selector 129 may work in conjunction with the user device 125 to perform the operations of the method 200.

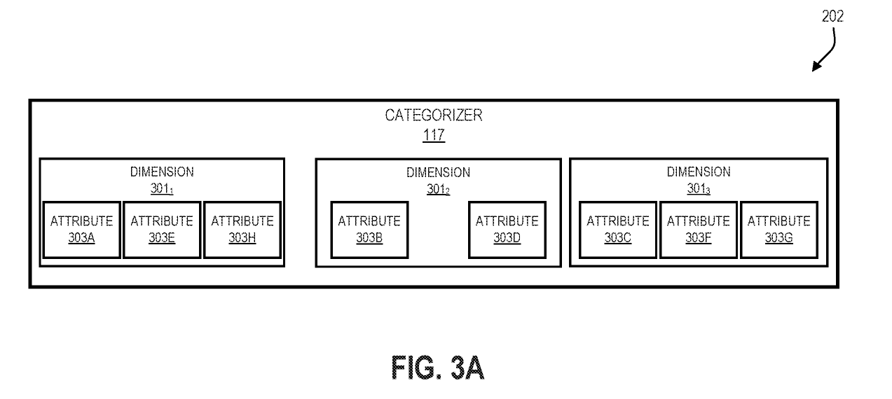

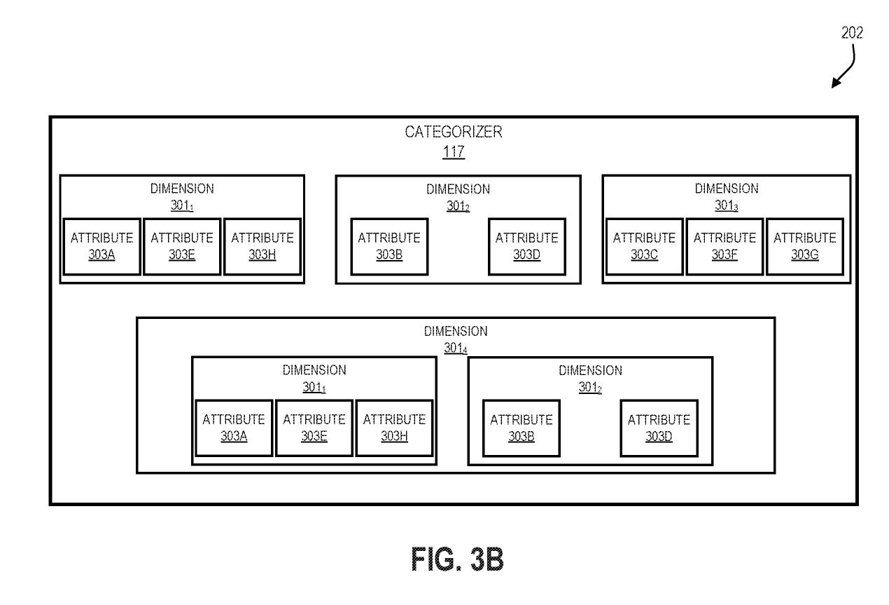

In one implementation, the method 200 may commence at operation 202 with categorization of attributes from a plurality of attributes into dimensions by the categorizer 117. FIG. 3A shows the categorization of attributes 303 into dimensions 301 by operation 202 according to one example implementation. As shown in FIG. 3A, the attributes 303A-303G are categorized into the dimensions 301₁-301₃. Each dimension 301 may include two or more attributes 303 and the attributes 303 may be categorized into each dimension 301 based on a common characteristic chosen for that dimension 301 such that all of the attributes 303 in each dimension 301 share the common characteristic chosen for that dimension 301. For example, the common characteristic for the dimension 301₁ may be “engagement” and each of the attributes 303A, 303E, and 303H in the dimension 301₁ is related to the amount a customer 105 engages with a company associated with the customer service manager 111. For instance, an attribute value 103 corresponding to attribute 303A may indicate how often a customer 105 contacts the customer service manager 111, an attribute value 103 corresponding to attribute 303E may indicate how often a customer 105 contacts customer support, and an attribute value 103 corresponding to attribute 303H may indicate how many training videos a customer 105 has viewed.

In some implementations, one or more dimensions 301 may be used to create another dimension 301. For example, FIG. 3B shows a dimension 301₄ which is based on the dimensions 301₁ and 301₂ according to one example implementation. As shown in the example of FIG. 3B, the dimension 301₄ includes the attributes 303A, 303B, 303D, 303E, and 303H (i.e., the attributes 303A, 303E, and 303H from the dimension 301₁ and the attributes 303B and 303D from the dimension 301₂). Accordingly, as shown here, a dimension 301 may be derived based on other dimensions 301. This generation of dimensions 301 based on other dimensions 301 may be extended to additional levels (e.g., a dimension 301 generated based on dimension 301₄ and another dimension 301). In the remaining description, the dimensions 301₁-301₃ of FIG. 3A will be used to explain different example implementations; however, it is understood that dimension 301₄ of FIG. 3B could be similarly used.

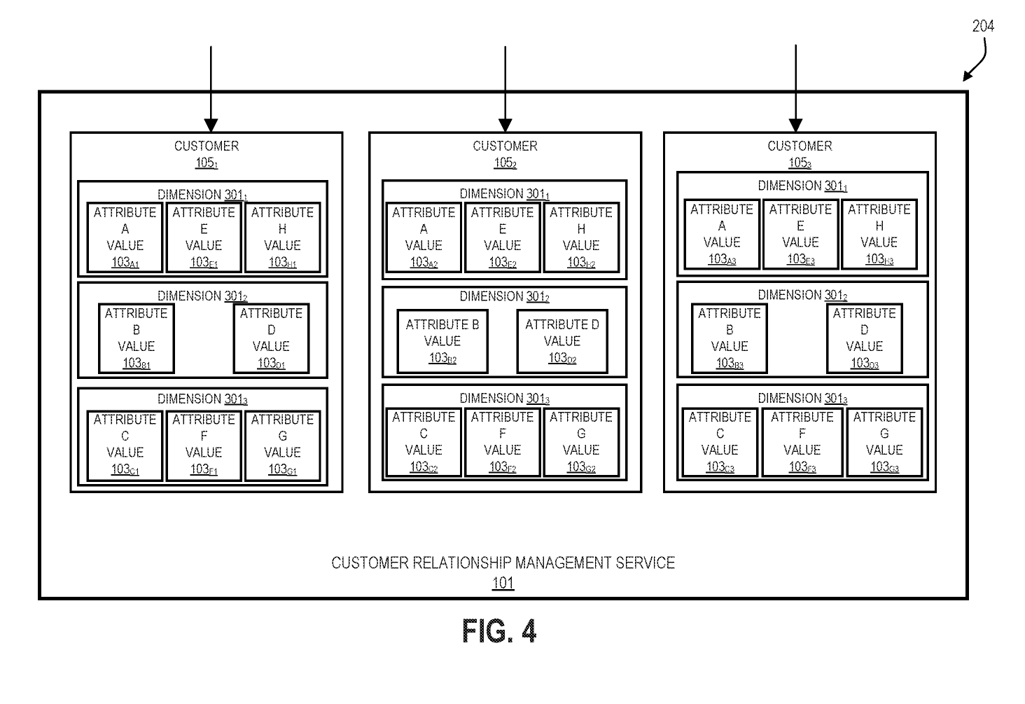

At operation 204, the customer relationship management service 101 may receive attribute values 103 for one or more customers 105 that describe behaviors and characteristics of the associated customer 105. For example, FIG. 4 shows the customer relationship management service 101 receiving attribute values 103 for one or more customers 105 according to one example implementation. As shown in FIG. 4, the customer relationship management service 101 may receive attribute values 103_{A1-H1} corresponding to customer 105₁, attribute values 103_{A2-H2} corresponding to customer 105₂, and attribute values 103_{A3-H3} corresponding to customer 105₃. Each of the attribute values 103 received at operation 204 correspond to an attribute 303. For example, attribute values 103_{A1}, 103_{A2}, and 103_{A3} correspond to attribute 303A, attribute values 103_{B1}, 103_{B2}, and 103_{B3} correspond to attribute 303B, attribute values 103_{C1}, 103_{C2}, and 103_{C3} correspond to attribute 303C, etc. Although shown as the attribute values 103 being received at the same time, the attribute values 103 may be received at different times and from potentially multiple sources. For example, the attribute values 103_{A1}, 103_{A2}, and 103_{A3}, which correspond to attribute 303A and may indicate how often the customer 105₁ contacts the customer service manager 111, may be received from a customer service manager system (e.g., an electronic device of the customer service manager 111 that keeps tracks of how often customers 105 contact the customer service manager 111) at a prescribed interval (e.g., at three-hour intervals). In contrast, the attribute values 103_{H1}, 103_{H2}, and 103_{H3}, which corresponds to attribute 303H and may indicate how many training videos the customer 105₁ has viewed, may be received from a training management system in real time as the attribute values 103_{H1}, 103_{H2}, and 103_{H3} are updated. The sources of the received attribute values 103 may be external to the customer relationship management system 100 or within the customer relationship management system 100.

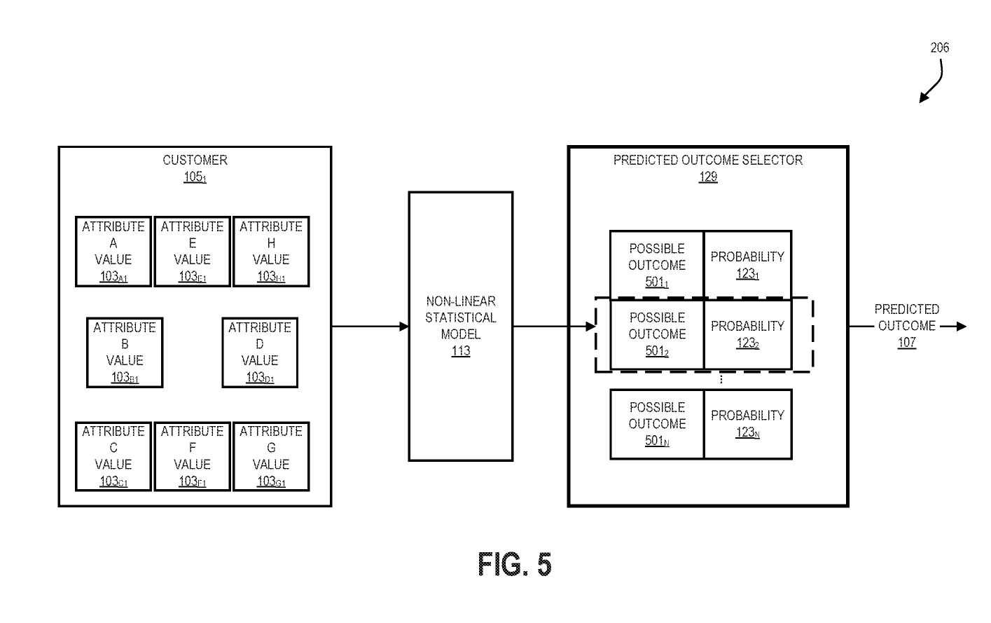

At operation 206, probabilities 123 for a plurality of possible outcomes are computed using the non-linear statistical model 113 and a predicted outcome 107 is selected for the customer 105₁ based on the probabilities by the predicted outcome selector 129. FIG. 5 shows operation 206 according to one example implementation. As shown in FIG. 5, the attribute values 103_{A1-H1} of the customer 105₁ are input to the non-linear statistical model 113 and the non-linear statistical model 113 computes probabilities 123 of possible outcomes 501_{1-N}. The predicted outcome selector 129 selects the possible outcome 501_{1-N} with the highest probability 123 as the predicted outcome 107 for the customer 105₁. In the example shown in FIG. 5, the probability 123₂ of possible outcome 501₂ is the highest amongst the probabilities 123_{1-N} of the possible outcomes 501_{1-N} such that possible outcome 501₂ is selected by the predicted outcome selector 129 as the predicted outcome 107 for the customer 105₁.

At operation 208, a dimensional influence score 109A may be computed for each dimension 301 in the plurality of dimensions 301₁-301₃ based on multiple applications of the non-linear statistical model 113 on different combinations of other pieces of data 121 with the attribute values 103 for the customer 105₁ in that dimension 301. In one implementation, the other pieces of data 121 are attribute values 103 independent of the dimension 301 and the customer 105₁ for which the dimensional influence score 109A is being computed. Operation 208 may be divided into a set of sub-operations 208A-208D, which will be described below.

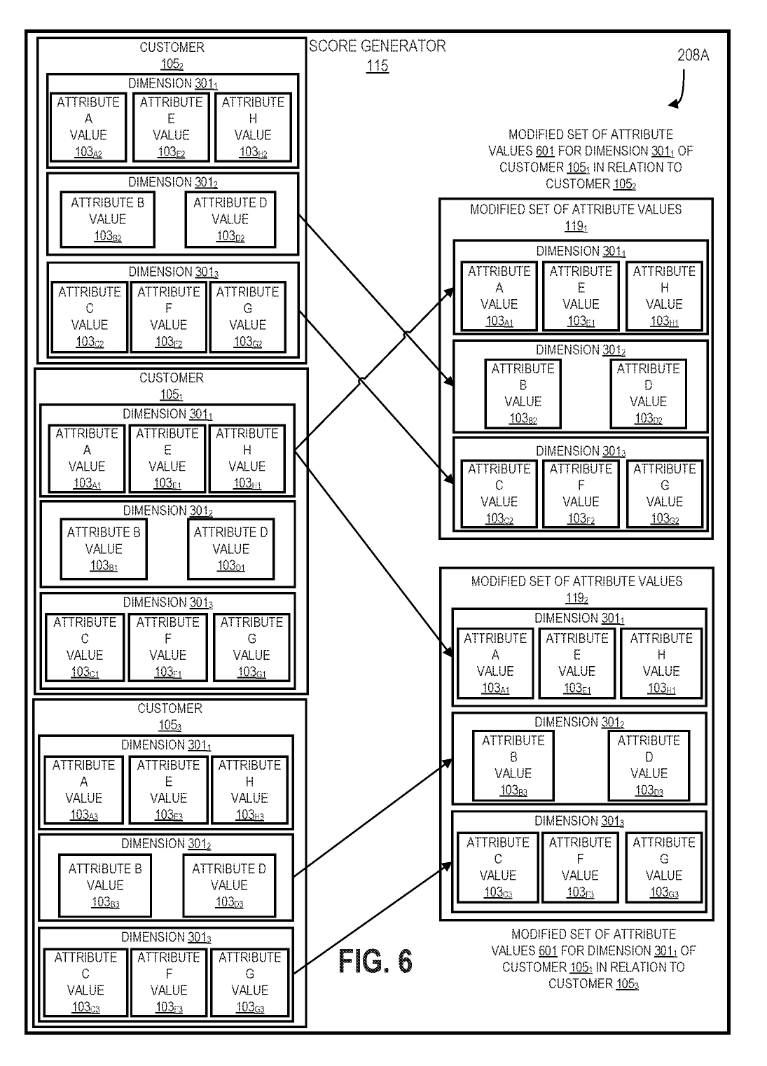

At sub-operation 208A the score generator 115 may generate a plurality of modified sets of attribute values 119. FIG. 6 shows generation of two modified sets of attribute values 119 by the score generator 115 according to one example implementation. As shown in FIG. 6, the modified sets of attribute values 119₁ includes the attribute values 103 for dimension 301₁ of customer 105₁ and the attribute values 103 for dimensions 301₂ and 301₃ of customer 105₂. The modified sets of attribute values 119₂ includes the attribute values 103 for dimension 301₁ of customer 105₁ and the attribute values 103 for dimensions 301₂ and 301₃ of customer 105₃. In these examples of modified sets of attribute values 119, the attribute values 103 for dimensions 301₂ and 301₃ of customer 105₂ are considered the other pieces of data 121 in relation to the modified sets of attribute values 119₁ and the attribute values 103 for dimensions 301₂ and 301₃ of customer 105₃ are considered the other pieces of data 121 in relation to the modified sets of attribute values 119₂.

Although shown as the modified sets of attribute values 119 being generated for the customer 105₁ in relation to all other customers 105 (e.g., the customers 105₂ and 105₃), in some implementations modified sets of attribute values 119 may be generated for the customer 105₁ in relation to a subset of all other customers 105. For example, modified sets of attribute values 119 may be generated for the customer 105₁ in relation to only those customers 105 that share a predefined characteristic (predefined by the customer service manager 111 or an administrator of the customer relationship management service 101) with the customer 105₁ (as possibly described by attribute values 103). For instance, only customers 105 that have a number of employees that is within 20% of the number of employees of the customer 105₁ are used to generate modified sets of attribute values 119 for the customer 105₁. In this implementation, score(s) 109 for the customer 105₁ are computed based on only those customers 105 that are similar to the customer 105₁ (e.g., share the predefined characteristic). In this way the score(s) 109 for the customer 105₁ will not be skewed by other customers 105 that are materially different from the customer 105₁ (e.g., do not share the predefined characteristic)

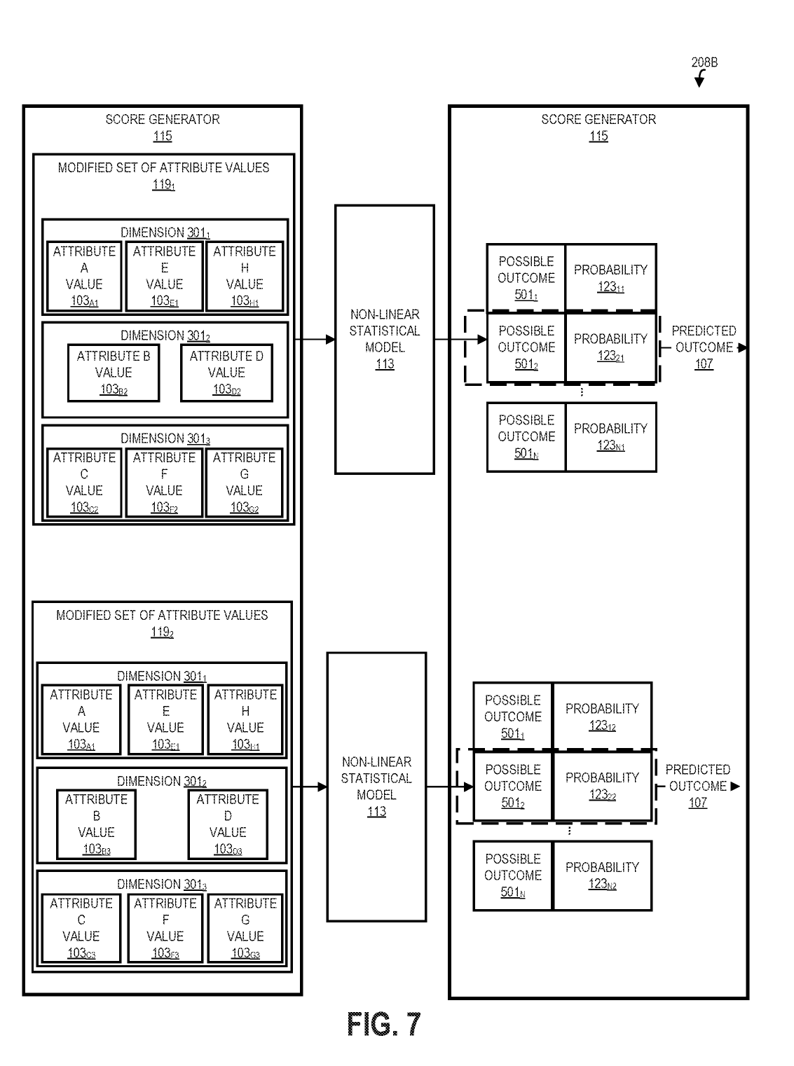

At sub-operation 208B, the non-linear statistical model 113 may compute probabilities 123 of possible outcomes 501 for each of the modified sets of attribute values 119 and the score generator 115 may select a predicted outcome 107 for each of the modified sets of attribute values 119 based on the probabilities 123 of possible outcomes 501 for each of the modified sets of attribute values 119. FIG. 7 shows an example of sub-operation 208B according to one example implementation. As shown in FIG. 7, the modified set of attribute values 119₁ is input to the non-linear statistical model 113 and the non-linear statistical model 113 computes probabilities 123_{11-N1} of possible outcomes 501_{1-N}. The score generator 115 selects the possible outcome 501_{1-N} with the highest probability 123 as the predicted outcome 107 for the modified set of attribute values 119₁. Similarly, the modified set of attribute values 119₂ is input to the non-linear statistical model 113 and the non-linear statistical model 113 computes probabilities 123_{12-N2} of possible outcomes 501_{1-N}. The score generator 115 selects the possible outcome 501_{1-N} with the highest probability 123 as the predicted outcome 107 for the modified set of attribute values 119₂. In the example of FIG. 7, the probability 123₂₁ corresponding to the possible outcome 501₂ is the highest probability 123 for the modified set of attribute values 119₁ and the probability 123₂₂ corresponding to the possible outcome 501₂ is the highest probability 123 for the modified set of attribute values 119₂.

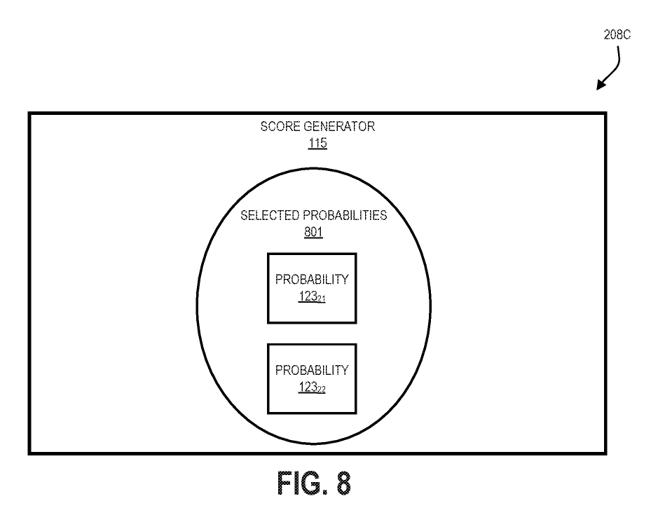

At sub-operation 208C probabilities 123 for the modified sets of attribute values 119 are selected that have a predicted outcome 107 that match the predicted outcome 107 for the customer 105₁. FIG. 8 shows probabilities 123 that are selected 801 at sub-operation 208C based on the examples of FIG. 5 and FIG. 7 according to one example implementation. In particular, as noted above, the predicted outcome 107 for the customer 105₁ in relation to the example of FIG. 5 is the possible outcome 501₂ since the probability 123₂ is the highest amongst the probabilities 123_{1-N}. Further, the predicted outcome 107 of the both the modified set of attribute values 119₁ and the modified set of attribute values 119₂ in relation to the example of FIG. 7 is also the possible outcome 501₂ since the probability 123₂₁ is the highest amongst the probabilities 123_{11-N1} and the probability 123₂₂ is the highest amongst the probabilities 123_{12-N2}. Since the predicted outcome 107 of the modified set of attribute values 119₁ is the same as the predicted outcome 107 of the customer 105₁, the probability 123₂₁ is selected at sub-operation 208C. Similarly, since the predicted outcome 107 of the modified set of attribute values 119₂ is the same as the predicted outcome 107 of the customer 105₁, the probability 123₂₂ is selected at sub-operation 208C.

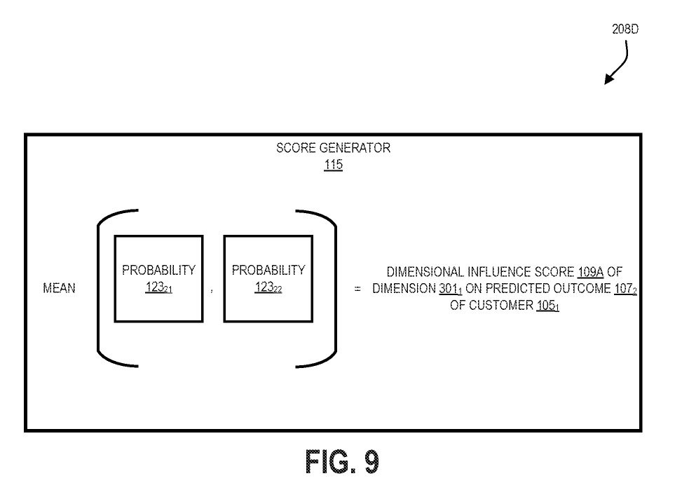

At sub-operation 208D, a mean of the selected probabilities 801 may calculated by the score generator 115 to generate a mean probability. The mean probability may be the dimensional influence score 109A for a dimension 301 of a customer 105. For example, as shown in the example implementation of FIG. 9, using the examples of the FIGS. 3-8, the mean of the selected probabilities 801 generates a mean probability that is the dimensional influence score 109A for the dimension 301₁ of the customer 105₁.

At sub-operation 208E, the customer relationship management service 101 may cause a representation 127 of the dimensional influence score 109A for the dimension 301₁ of the customer 105₁ to be displayed to the customer service manager 111. In some implementations, the representation 127 may include the dimensional influence score 109A for the dimension 301₁ of the customer 105₁ and the predicted outcome 107 of the customer 105₁ such that the dimensional influence score 109A may be presented to the customer service manager 111 along with the predicted outcome 107 of the customer 105₁. Although described for an individual dimension 301 (e.g., the dimension 301₁), the sub-operations 208A-208E may be performed for each dimension 301 of a customer 105 (e.g., the customer 105₁) such that a dimensional influence score 109A may be presented for each dimension 301 of the customer 105 (e.g., the representation 127 includes a dimensional influence score 109A for each dimension 301 of the customer 105). Further, the operations 206 and 208 may be performed for each customer 105 such that a dimensional influence score 109A may be presented for each dimension 301 of each customer 105 (e.g., the representation 127 includes a dimensional influence score 109A for each dimension 301 of each customer 105). In one implementation, sub-operation 208E may include transmitting the representation 127 to the user device 125 of the customer service manager 111 such that the user device 125 may present the representation 127 on a display.

In one implementation, the representation 127 includes one or more of graphics (e.g., charts) and text. Further, the representation 127 may be encoded using any technique or language (e.g., Hypertext Markup Language (HTML)).

As shown in FIG. 1, dimensional influence scores 109A and the predicted outcome 107 of the customer 1051 may be transmitted to the user device 125 such that the user device 125 can cause the presentation on a display of a representation 127 of dimensional influence scores 109A and the predicted outcome of the customer 105₁ to the customer service manager 111. As previously described, the dimensional influence score 109A indicates the collective influence of attributes 103 in a dimension 301 on the predicted outcome 107 of a customer 105. For example, when a dimensional influence score 109A for the dimension 301₁ of the customer 105₁ is high, the attributes 303A, 303E, and 303H of the dimension 301₁ are very influential in the predicted outcome 107 of the customer 105₁. In this case, the customer service manager 111 may determine courses of action in relation to the attributes 303A, 303E, and 303H of the dimension 301₁ for the customer 105₁ (i.e., courses of action to prevent the predicted outcome 107 of the customer 105₁ or promote the predicted outcome 107 of the customer 105₁ (e.g., take no action) by targeting the attributes 303A, 303E, and 303H of the dimension 301₁ in relation to the customer 105₁).

Although dimensional influence scores 109A may indicate to the customer service manager 111 the collective influence of attributes 303 in dimensions 301 on a predicted outcome 107 of a customer 105₁, the dimensional influence scores 109A do not indicate the health of attributes 303 within dimensions 301. Namely, the dimensional influence scores 109A do not indicate whether attributes 303 within dimensions 301 of a customer 105 are unhealthy, such that improvement is possible, or healthy, such that improvement is not possible. To provide the customer service manager 111 a greater degree of information when determining a course of action for customers 105, dimensional health scores 109B may be computed by the score generator 115.

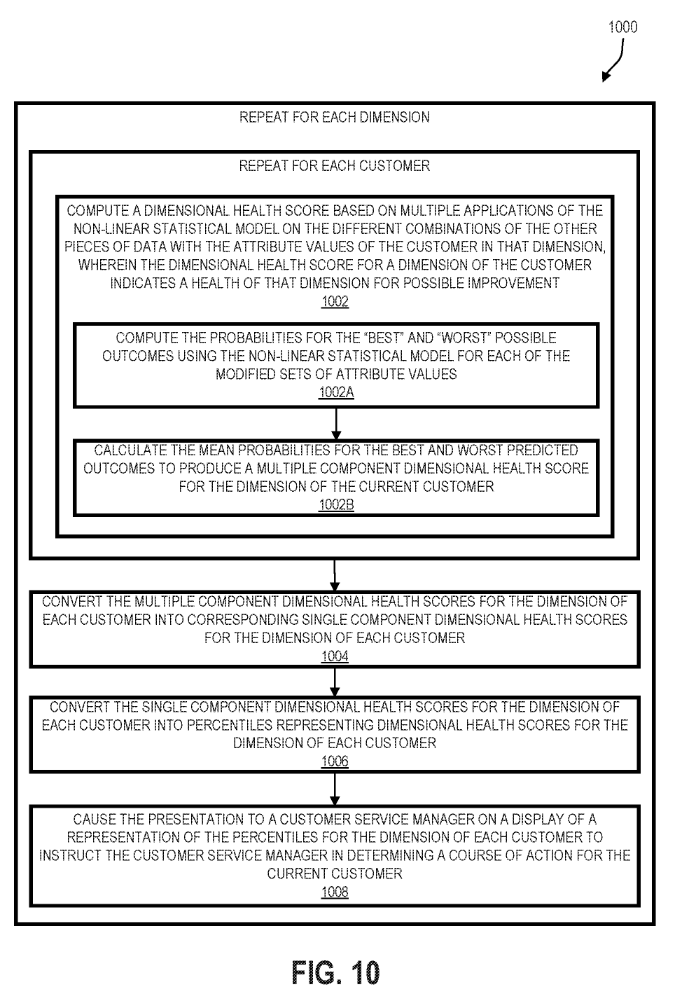

FIG. 10 shows a method 1000 for computing dimensional health scores 109B according to one example implementation. The operations in the flow diagram of FIG. 10 will be described with reference to the exemplary implementations of the other figures. However, it should be understood that the operations of the flow diagram can be performed by implementations other than those discussed with reference to the other figures, and the implementations discussed with reference to these other figures can perform operations different than those discussed with reference to the flow diagrams. Although described and shown in FIG. 10 in a particular order, the operations of the method 1000 are not restricted to this order. For example, one or more of the operations of the method 1000 may be performed in a different order or in partially or fully overlapping time periods. Accordingly, the description and depiction of the method 1000 is for illustrative purposes and is not intended to restrict to a particular implementation.

In some implementations, one or more of the operations of the method 1000 may be performed by components of the customer relationship management system 100. For example, one or more of the operations of the method 1000 may be performed by the customer relationship management service 101 and the user device 125. In particular, the non-linear statistical model 113 and the score generator 115 may work in conjunction with the user device 125 to perform the operations of the method 1000.

In some implementations, the method 1000 may commence after the method 200 completes or a portion of the method 200 completes. For example, after computing a dimensional influence score 109A for a dimension 301 of the customer 105₁, the method 1000 may be performed to compute a corresponding dimensional health score 109B for the dimension 301 of the customer 105₁.

In some implementations, the input to or the product of one or more operations of the method 200 may be used by the method 1000. For example, one or more of (1) the categorization of attributes 303 into dimensions by operation 202 of the method 200, (2) the attribute values 103 received by at operation 204 of the method 200, (3) the predicted outcome 107 of the customer 105₁ selected at operation 206 of the method 200, and (4) the modified sets of attribute values 119 generated by sub-operation 208A may be used by the method 1000.

At operation 1002, a dimensional health score 109B may be computed for each dimension 301 in the plurality of dimensions 301₁-301₃ based on multiple applications of the non-linear statistical model 113 on different combinations of other pieces of data 121 with the attribute values 103 for the customer 105₁ in that dimension 301. In one implementation, the other pieces of data 121 are attribute values 103 independent of the dimension 301 and the customer 105₁ for which the dimensional health score 109B is being computed. Operation 1002 may be divided into a set of sub-operations 1002A and 1002B, which will be described below.

At sub-operation 1002A, the probabilities 123 for the best and worst possible outcomes 501 are computed by the score generator 115 in relation to each of the modified sets of attribute values 119. In this implementation, the possible outcomes 501_{1-N} are scaled from a “best” possible outcome 501 to a “worst” possible outcome 501 such that possible outcome 501₁ is the best possible outcome 501 and possible outcome 501_{N} is the worst possible outcome 501. The best possible outcome 501₁ is the strongest possible relationship between a customer 105 and a company that the customer service manager 111 represents (e.g., the customer service manager 111 is an employee of the company with which the customer 105₁ has a relationship). For example, the best possible outcome 501₁ may be the customer 105₁ growing their relationship with the company. The worst possible outcome 501_{N} is the weakest possible relationship between a customer 105 and a company that the customer service manager 111 represents. For example, the worst possible outcome 501_{N} may be the customer 105₁ fully attriting their relationship with the company.

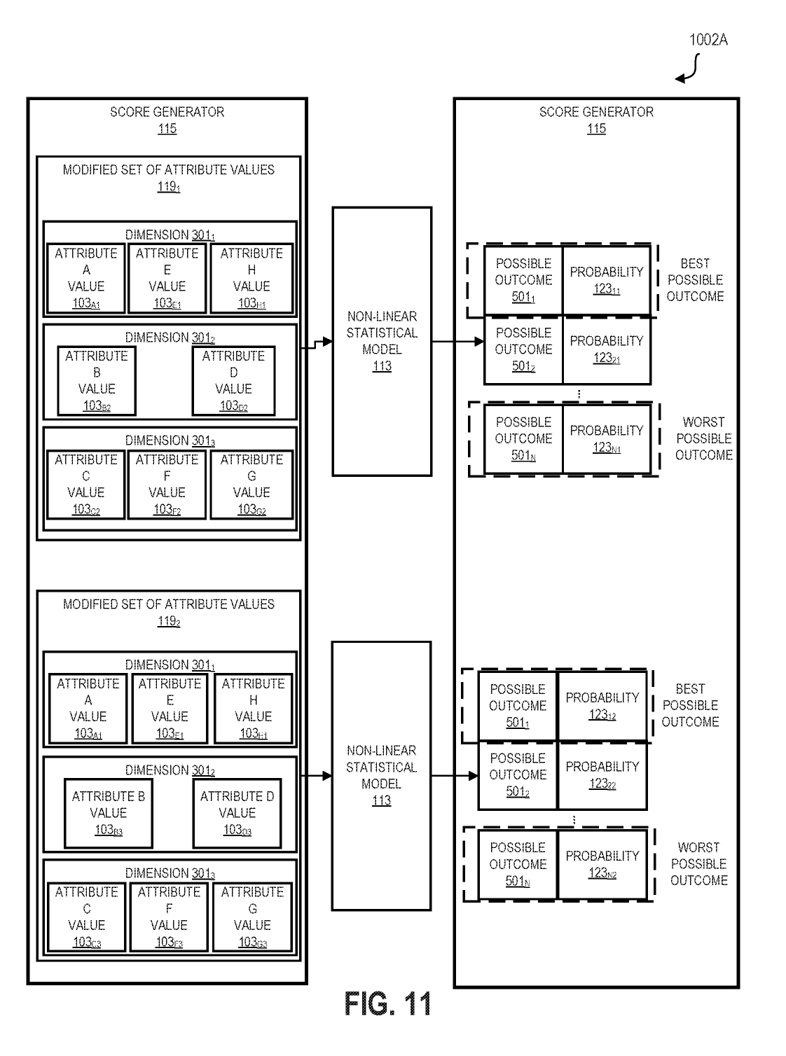

FIG. 11 shows computation of probabilities 123 for the best possible outcome 501₁ and worst possible outcome 501_{N} in relation to both the modified set of attribute values 119₁ and the modified set of attribute values 119₂ according to one example implementation. In particular, the modified set of attribute values 119₁ may be input to the non-linear statistical model 113 and the non-linear statistical model 113 computes the probability 123₁₁ of the best possible outcome 501₁ and the probability 123_{N1} of the worst possible outcome 501_{N}. Similarly, the modified set of attribute values 119₂ may be input to the non-linear statistical model 113 and the non-linear statistical model 113 computes the probability 123₁₂ of the best possible outcome 501₁ and the probability 123_{N2} of the worst possible outcome 501_{N}. These probabilities 123₁₁, 123_{N1}, 123₁₂, and 123_{N2} may have been previously computed by sub-operation 208B of the method 200. In such a case, these probabilities 123₁₁, 123_{N1}, 123₁₂, and 123_{N2} may not need to be recalculated by the method 1000.

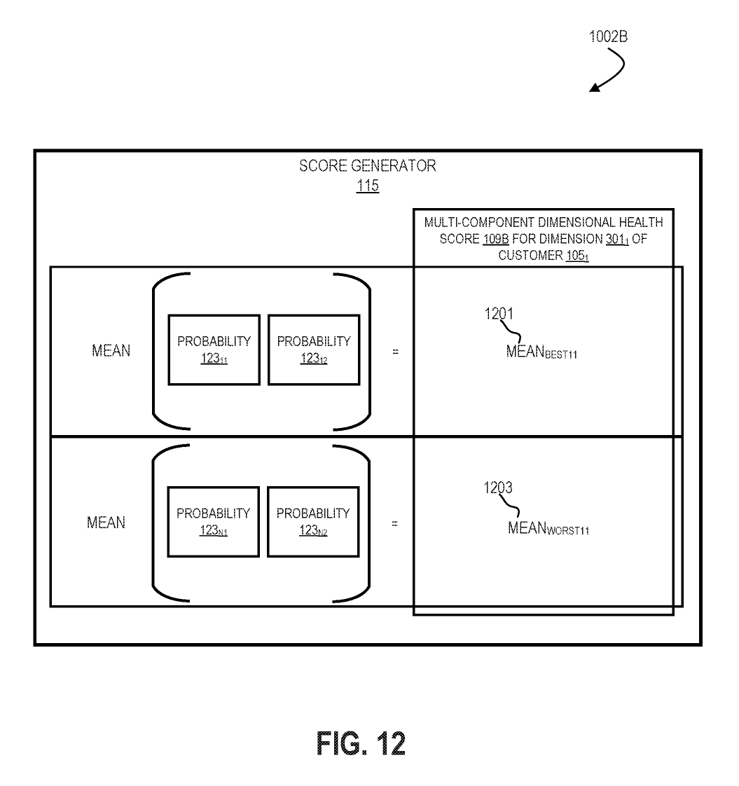

At sub-operation 1002B, the score generator 115 may calculate the mean probability for the probabilities 123 computed in relation to the modified sets of attribute values 119 for the best possible outcome 501₁ and the mean probability for the probabilities 123 computed in relation to the modified sets of attribute values 119 for the worst possible outcome 501_{N}. FIG. 12 shows calculation according to one example implementation of the mean probability (MEAN_{BEST11}) for the probabilities 123 computed in relation to the modified sets of attribute values 119 for the best possible outcome 501₁ and the mean probability (MEAN_{WORST11}) for the probabilities 123 computed in relation to the modified sets of attribute values 119 for the worst possible outcome 501_{N}. The MEAN_{BEST11} and MEAN_{WORST11} collectively represent the dimensional health score 109B₁₁ for dimension 301₁ of customer 105₁ using multiple components (e.g., (MEAN_{BEST11}, MEAN_{WORST11})).

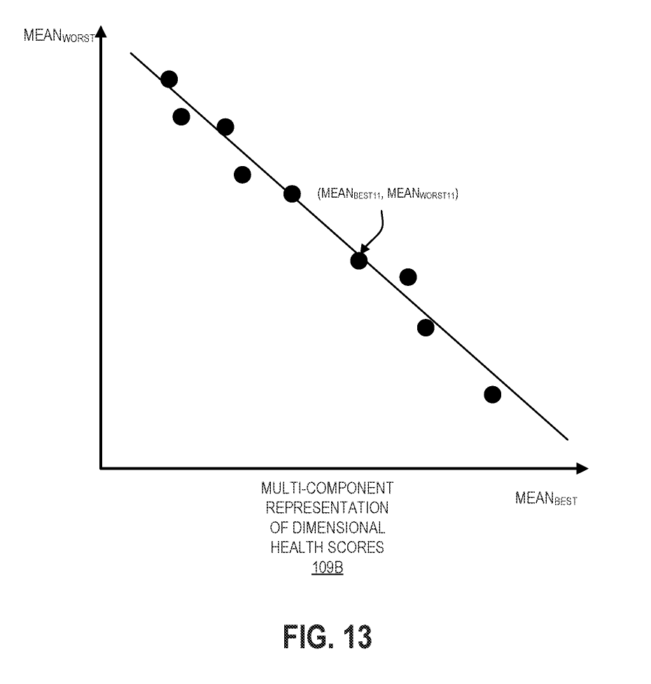

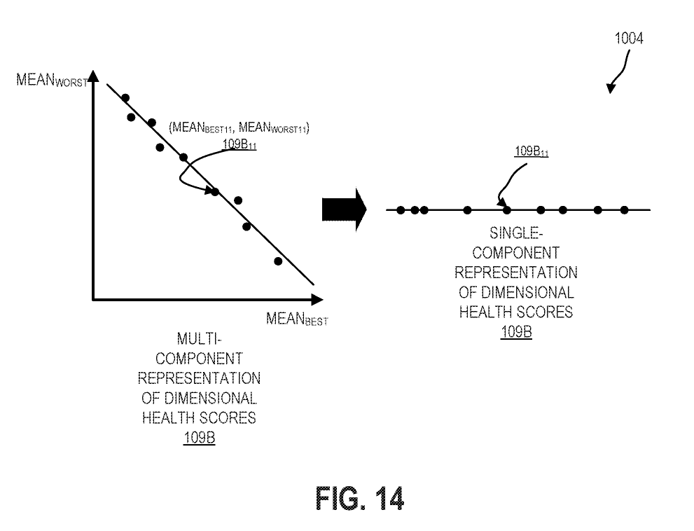

FIG. 13 shows the dimensional health score 109B₁₁ for dimension 301₁ of customer 105₁ using multiple components (e.g., (MEAN_{BEST11}, MEAN_{WORST11})) according to one example implementation. As shown in FIG. 13, the dimensional health score 109B₁₁ is plotted against dimensional health scores 109B for the dimension 301₁ of other customers 105, which may also be computed using operation 1002. Dimensional health scores 109B with the higher mean probabilities of the worst possible outcome 501_{N} move towards the top of the graph in FIG. 13 and dimensional health scores 109B with the higher mean probabilities of the best possible outcome 501₁ move towards the right of the graph in FIG. 13. Plotting the dimensional health score 109B₁₁ against other dimensional health scores 109B demonstrates the health for the dimension 301₁ of the customer 105₁ relative to the health of the same dimension 301₁ of other customers 105. To better represent the health for the dimension 301₁ of the customer 105₁, the dimensional health scores 109B for the dimension 301₁ of all customers 105 may be converted from multiple components to a single component at operation 1004. In one implementation, conversion of the dimensional health scores 109B from multiple components (MEAN_{BEST11}, MEAN_{WORST11}) to a single component may be performed by projecting the multi-component dimensional health scores 109B into the first principal component. FIG. 14 shows the conversion from multiple component dimensional health scores 109B to single component dimensional health scores 109B according to one example implementation.

At operation 1006 the single component dimensional health scores 109B may be converted to corresponding percentiles. In converting the single component dimensional health scores to percentiles, only those accounts are considered in a certain segment and certain point in time (e.g., customers 105 similar in size to customer 105₁, using forecasts for the month of June-2017). In the graph of FIG. 14, the single component dimensional health scores 109B to the left of the graph (e.g., higher mean probabilities of the worst possible outcome 501_{N} and lower mean probabilities of the best possible outcome 501₁) are given the lower percentiles than the single component dimensional health scores 109B to the right of the graph (e.g., lower mean probabilities of the worst possible outcome 501_{N} and higher mean probabilities of the best possible outcome 501₁). The highest percentile (e.g., 100) indicates that the corresponding dimension 301 of the customer 105 is healthy and there is not much if any room for improvement whereas the lowest percentile indicates that the corresponding dimension 301 of the customer 105 is unhealthy and there is a great deal of room for improvement.

At operation 1008, the customer relationship management service 101 may cause a representation 127 of the dimensional health score 109B for the dimension 301₁ of the customer 105₁, including the percentile of operation 1006, to be displayed to the customer service manager 111. As noted above, the method 1000 may be performed for each dimension 301 of each customer 105 such that multiple performances of operation 1008 causes the presentation of all dimensional health scores 109B for all dimensions 301 of all customers 105 to the customer service manager 111. In some implementations, the dimensional health scores 109B for all dimensions 301 of all customers 105 may be presented to the customer service manager 111 along with the corresponding dimensional influence scores 109A and the predicted outcomes 107 of all customers 105 (e.g., sub-operation 208E of the method 200 may be combined with the operation 1008 of the method 1000).

As shown in FIG. 1, dimensional influence scores 109A and the dimensional health scores 109B for all dimensions of all customers 105 and the predicted outcome 107 of the all customers 105 may be transmitted to the user device 125 such that the user device 125 can present on a display a representation 127 of the dimensional influence scores 109A, the dimensional health scores 109B, and the predicted outcome 107 to the customer service manager 111. As previously described, each dimensional influence score 109A indicates the collective influence of attributes 103 in a dimension 301 on the predicted outcome 107 of a customer 105 while a corresponding dimensional health score 109B indicates the collective health of the attributes 103 in a dimension 301 for possible improvement. The presentation of the dimensional influence scores 109A and the dimensional health scores 109B for dimensions 301 of customers 105 and the predicted outcomes 107 of customers 105 may instruct the customer service manager 111 in determining courses of action in relation to each of the customers 105. For example, the customer service manager 111 may easily identify customers 105 with poor predicted outcomes 107 (e.g., partial or full attrition) and determine dimensions 301 of attributes 303 that are influential on the predicted outcome (e.g., based on a dimensional influence score 109A) and are capable of being improved upon (e.g., based on a dimensional health score 109B) such that the customer service manager 111 may determine a course of action to improve attribute 303 in the determined dimension 301 with the goal of changing the poor predicted outcome 107.

In some implementations, a history of the scores 109 and the predicted outcomes 107 may be presented to the customer service manager 111 such that the customer service manager 111 may see the impact of taken courses of action. This may further instruct the customer service manager 111 in determining additional courses of action by indicating what previous courses of action resulted in changes to the scores 109 and/or the predicted outcome 107 and what previous courses of action did not result in changes to the scores 109 and/or the predicted outcome 107.

One or more parts of the above implementations may include software and/or a combination of software and hardware. An electronic device (also referred to as a computing device, computer, etc.) includes hardware and software, such as a set of one or more processors coupled to one or more machine-readable media to store code (which is composed of software instructions and which is sometimes referred to as computer program code or a computer program) for execution on the set of processors and/or to store data. A machine-readable media (also called computer-readable media), such as machine-readable storage media (e.g., magnetic disks, optical disks, read only memory (ROM), Flash memory, phase change memory, solid state drives (SSDs)) and machine-readable transmission media (also called a carrier) (e.g., electrical, optical, radio, acoustical or other form of propagated signals—such as carrier waves, infrared signals). For instance, an electronic device may include non-volatile memory (with slower read/write times, e.g., magnetic disks, optical disks, read only memory (ROM), Flash memory, phase change memory, SSDs) and volatile memory (e.g., dynamic random access memory (DRAM), static random access memory (SRAM)), where the non-volatile memory persists the code/data even when the electronic device is turned off (when power is removed), and the electronic device copies that part of the code that is to be executed by the processor(s) of that electronic device from the non-volatile memory into the volatile memory of that electronic device during operation because volatile memory typically has faster read/write times. As another example, an electronic device may include a non-volatile memory (e.g., phase change memory) to store the code/data when the electronic device is turned off, and that same non-volatile memory has sufficiently fast read/write times such that, rather than copying the part of the code to be executed into volatile memory, the code/data may be provided directly to the processor(s) (e.g., loaded into a cache of the processor(s)); in other words, this non-volatile memory operates as both long term storage and main memory, and thus the electronic device may have no or only a small amount of DRAM for main memory. Typical electronic devices also include a set of one or more physical network interface(s) to establish network connections (to transmit and/or receive code and/or data using propagating signals) with other electronic devices. Thus, an electronic device may store and transmit (internally and/or with other electronic devices over a network).

Electronic devices are used for a variety of purposes. For example, an electronic device (sometimes referred to as a server electronic device) may execute code that cause it to operate as one or more servers used to provide a service to another electronic device (sometimes referred to as a client electronic device, a client computing device, or a client device) that executes client software (sometimes referred to as an end user client) to communicate with the service. The server and client electronic devices may be operated by users respectively in the roles of administrator (also known as an administrative user) and end user.

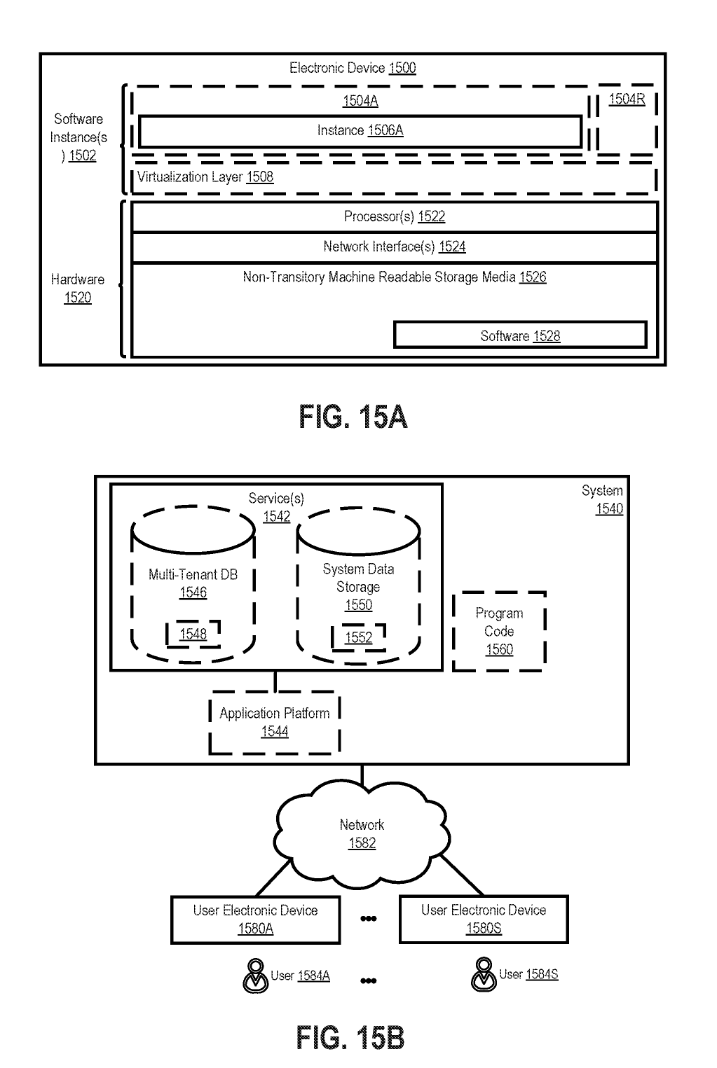

FIG. 15A is a block diagram illustrating an electronic device according to some example implementations. FIG. 15A includes hardware 1520 comprising a set of one or more processor(s) 1522, a set of one or more network interfaces 1524 (wireless and/or wired), and non-transitory machine-readable storage media 1526 having stored therein software 1528 (which includes instructions executable by the set of one or more processor(s) 842). Each of the previously described user devices 125 and the customer relationship management service 101 may be implemented in one or more electronic devices 1500. In one implementation: 1) each of the end user clients is implemented in a separate one of the electronic devices 1500 (e.g., in a user device operated by a user, the software 1528 includes the software to implement one of the end user clients, including software to interface with the customer relationship management service 101 (e.g., a web browser, a native client, a portal, a command-line interface, an application program interface (API) based upon protocols such as Simple Object Access Protocol (SOAP), Representational State Transfer (REST), etc.)); 2) the customer relationship management service 101 is implemented in a separate set of one or more of the electronic devices 1500 (in which case, the software 1528 is the software to implement the customer relationship management service 101 and it is executed the set of one or more server electronic devices); and 3) in operation, the user electronic devices and the electronic device(s) implementing the customer relationship management service 101 would be commutatively coupled (e.g., by a network) and would establish between them (or through one or more other layers) connections for submitting attribute values 103 to the customer relationship management service 101 and returning predicted outcomes 107 and scores 109. Other configurations of electronic devices may be used in other implementations (e.g., an implementation in which the end user client and the customer relationship management service 101 are implemented on a single electronic device).

In electronic devices that use compute virtualization, the processor(s) 1522 typically execute software to instantiate a virtualization layer 1508 and software container(s) 1504A-R (e.g., with operating system-level virtualization, the virtualization layer 1508 represents the kernel of an operating system (or a shim executing on a base operating system) that allows for the creation of multiple software containers 1504A-R (representing separate user space instances and also called virtualization engines, virtual private servers, or jails) that may each be used to execute a set of one or more applications; with full virtualization, the virtualization layer 1508 represents a hypervisor (sometimes referred to as a virtual machine monitor (VMM)) or a hypervisor executing on top of a host operating system, and the software containers 1504A-R each represent a tightly isolated form of software container called a virtual machine that is run by the hypervisor and may include a guest operating system; with para-virtualization, an operating system or application running with a virtual machine may be aware of the presence of virtualization for optimization purposes). Again, in electronic devices where compute virtualization is used, during operation an instance of the software 1528 (illustrated as instance 1506A) is executed within the software container 1504A on the virtualization layer 1508. In electronic devices where compute virtualization is not used, the instance 1506A on top of a host operating system is executed on the “bare metal” electronic device 1500. The instantiation of the instance 1506A, as well as the virtualization layer 1508 and software containers 1504A-R if implemented, are collectively referred to as software instance(s) 1502.

Alternative implementations of an electronic device may have numerous variations from that described above. For example, customized hardware and/or Exemplary Environment

FIG. 15B is a block diagram of an environment where a customer relationship management system 100 may be deployed, according to some implementations. An on-demand service is made available to outside users that do not need to necessarily be concerned with building and/or maintaining a system, but instead may be available for their use when the users need the service (e.g., on the demand of the users). A system 1540 includes hardware (a set of one or more electronic devices) and software to provide service(s) 1542, including the customer relationship management service 101. The system 1540 is coupled to user electronic devices 1580A-S over a network 1582. The service(s) 1542 may communication with each other and/or with one or more of the user electronic devices 1580A-S via one or more Application Programming Interface(s) (APIs) (e.g., a Representational State Transfer (REST) API). The user electronic devices 1580A-S are operated by users 1584A-S.

In one implementation, the system 1540 is a multi-tenant cloud computing architecture supporting multiple services, such as a customer relationship management (CRM) service (e.g., Sales Cloud by salesforce.com, Inc.), a contracts/proposals/quotes service (e.g., Salesforce CPQ by salesforce.com, Inc.), customer support service (e.g., Service Cloud and Field Service Lightning by salesforce.com, Inc.), marketing service (e.g., Marketing Cloud, Salesforce DMP, and Pardot by salesforce.com, Inc.), commerce service (e.g., Commerce Cloud Digital, Commerce Cloud Order Management, and Commerce Cloud Store by salesforce.com, Inc.), communication with external business data sources (e.g., Salesforce Connect by salesforce.com, Inc.), productivity service (e.g., Quip by salesforce.com, Inc.), database as a service (e.g., Database.com™ by salesforce.com, Inc.), Platform as a Service (PAAS) (e.g., execution runtime and application (app) development tools; such as, Heroku™ Enterprise, Thunder, and Force.com® and Lightning by salesforce.com, Inc.), analytics service (e.g., Einstein Analytics, Sales Analytics, and/or Service Analytics by salesforce.com, Inc.), community service (e.g., Community Cloud and Chatter by salesforce.com, Inc.), Internet of Things service (e.g., Salesforce IOT and IoT Cloud by salesforce.com, Inc.), and industry specific services (e.g., Financial Services Cloud and Health Cloud by salesforce.com, Inc.) and/or Infrastructure as a Service (IAAS) (e.g., virtual machines, servers, and/or storage). For example, system 1540 may include an application platform 1544 that enables a Platform as a Service (PAAS) for creating, managing, and executing one or more applications developed by the provider of the application platform 1544, users accessing the system 1540 via one or more of user electronic devices 1580A-S, or third-party application developers accessing the system 1540 via one or more of user electronic devices 1580A-S.

In some implementations, one or more of the service(s) 1542 may utilize one or more multi-tenant databases 1546, as well as system data storage 1550 for system data 1552 accessible to system 1540. In certain implementations, the system 1540 includes a set of one or more servers that are running on server electronic devices and that are configured to handle requests for any authorized user associated with any tenant (there is no server affinity for a user and/or tenant to a specific server). The user electronic device 1580A-S communicate with the server(s) of system 1540 to request and update tenant-level data and system-level data hosted by system 1540, and in response the system 1540 (e.g., one or more servers in system 1540) automatically may generate one or more Structured Query Language (SQL) statements (e.g., one or more SQL queries) that are designed to access the desired information from the one or more multi-tenant database 1546 and/or system data storage 1550.

In some implementations, the service(s) 1542 are implemented using virtual applications dynamically created at run time responsive to queries from the user electronic devices 1580A-S and in accordance with metadata, including: 1) metadata that describes constructs (e.g., forms, reports, workflows, user access privileges, business logic) that are common to multiple tenants; and/or 2) metadata that is tenant specific, describes tenant specific constructs (e.g., tables, reports, dashboards, interfaces, etc.) and is stored in a multi-tenant database. To that end, the program code 1560 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 1544 includes an application setup mechanism that supports application developers' creation and management of applications, which may be saved as metadata by save routines. Invocations to such applications, including the customer relationship management service 101, may be coded using Procedural Language/Structured Object Query Language (PL/SOQL) that provides a programming language style interface. A detailed description of some PL/SOQL language implementations is discussed in U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007. Invocations to applications may be detected by one or more system processes, which manages retrieving application metadata for the tenant making the invocation and executing the metadata as an application in a software container (e.g., a virtual machine).

Network 1582 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, or similar wired and/or wireless protocols, and may include one or more intermediary devices for routing data between the system 1540 and the user electronic devices 1580A-S.

Each user electronic device 1580A-S (such as a desktop personal computer, workstation, laptop, Personal Digital Assistant (PDA), smart phone, etc.) typically includes one or more user interface devices, such as a keyboard, a mouse, a trackball, a touch pad, a touch screen, a pen or the like, for interacting with a graphical user interface (GUI) provided on a display (e.g., a monitor screen, a LCD display, etc.) in conjunction with pages, forms, applications and other information provided by system 1540. For example, the user interface device can be used to access data and applications hosted by system 1540, and to perform searches on stored data, and otherwise allow a user to interact with various GUI pages that may be presented to a user. User electronic devices 1580A-S might communicate with system 1540 using TCP/IP (Transfer Control Protocol and Internet Protocol) and, at a higher network level, use other Internet protocols to communicate, such as Hypertext Transfer Protocol (HTTP), FTP, Andrew File System (AFS), Wireless Application Protocol (WAP), File Transfer Protocol (FTP), Network File System (NFS), an application program interface (API) based upon protocols such as Simple Object Access Protocol (SOAP), Representational State Transfer (REST), etc. In an example where HTTP is used, one or more user electronic devices 1580A-S might include an HTTP client, commonly referred to as a “browser”, for sending and receiving HTTP messages to and from server(s) at system 1540, thus allowing users of the user electronic device 1580A-S to access, process and view information, pages and applications available to it from system 1540 over network 1582.

In the above description, numerous specific details such as resource partitioning/sharing/duplication implementations, types and interrelationships of system components, and logic partitioning/integration choices are set forth in order to provide a more thorough understanding. It will be appreciated, however, by one skilled in the art, that the invention may be practiced without such specific details. In other instances, control structures, logic implementations, opcodes, means to specify operands, and full software instruction sequences have not been shown in detail since those of ordinary skill in the art, with the included descriptions, will be able to implement what is described without undue implementation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

In the following description and claims, the term “coupled,” along with its derivatives, may be used. “Coupled” is used to indicate that two or more elements, which may or may not be in direct physical or electrical contact with each other, co-operate or interact with each other.

The operations in the flow diagrams are be described with reference to the exemplary implementations in the other figures. However, the operations of the flow diagrams can be performed by implementations other than those discussed with reference to the other figures, and the implementations discussed with reference to these other figures can perform operations different than those discussed with reference to the flow diagrams.

While the flow diagrams in the figures show a particular order of operations performed by certain implementations, it should be understood that such order is exemplary (e.g., alternative implementations may perform the operations in a different order, combine certain operations, overlap certain operations, etc.).

While the exemplary implementations may include an on-demand database service environment provided by an application server with a front end for an on-demand database service capable of supporting multiple tenants, alternative implementations are within the spirit and scope of the appended claims (e.g., other database architectures may be used, such as ORACLE® or DB2® by IBM).

While the above description includes several exemplary implementations, those skilled in the art will recognize that the invention is not limited to the implementations described and can be practiced with modification and alteration within the spirit and scope of the appended claims. The description is thus illustrative instead of limiting.

Although the figures and the description herein is presented in the context of customer relationship management, the methods, systems, and devices described herein may be equally applied to other domains that involve selecting predicted outcomes for respective entities based on attributes of those entities input into a statistical model. For example, other domains in which statistical models may be used to generate predicted outcomes include stock price predictions, insurance event predictions (e.g., home, automobile, health, etc.), user action predictions within a user interface, political election predictions, device failure predictions, business-to-consumer behavior predictions, and business-to-business predictions other than or in addition to the business-to-business customer relationship management described above. In these diverse domains, predicted outcomes for customers may be replaced with predicted outcomes for entities, the customer relationship management service 101 may be replaced with an entity management service, and the customer relationship management system 100 may be replaced with an entity management system. As used herein, an entity may be an individual, an organization, a physical or conceptual object, or any other similar construct that may be described by attributes and for which a prediction or forecast of a future state or action may be generated.

What is claimed is:

1. A method for determining the influence of attributes on a predicted outcome for a customer, wherein the predicted outcome was selected from a plurality of possible outcomes based on probabilities generated by application of a non-linear statistical model on a plurality of input attributes, wherein there is an attribute value for each of the plurality of attributes that describes a behavior or a characteristic of the customer, the method comprising:
computing, by a computing device, for each dimension in a plurality of dimensions, a first score based on multiple applications of the non-linear statistical model on different combinations of other pieces of data with the attribute values for the customer in that dimension, wherein each attribute in the plurality of attributes was categorized into one of the plurality of dimensions based on a common characteristic chosen for that dimension, wherein each dimension in the plurality of dimensions includes two or more of the plurality of attributes, wherein all of the attributes in each dimension in the plurality of dimensions share the common characteristic chosen for that dimension, wherein each of the other pieces of data for each of the plurality of dimensions are attribute values independent of the dimension and the customer, wherein the first score for the customer for each of the plurality of dimensions indicates the influence of that dimension on the predicted outcome for the customer; and
causing the presentation on a display of a representation of the first scores for the plurality of dimensions to a user to instruct the user in determining a course of action.

2. The method of claim 1, wherein the computing a first score for the customer for a first dimension in the plurality of dimensions using the non-linear statistical model includes computing the first score for the customer for the first dimension based on attribute values of the customer for the first dimension and at least on attribute values for at least one other customer for a second dimension in the plurality of dimensions.

3. The method of claim 2, wherein the computing a first score for the customer for the second dimension in the plurality of dimensions using the non-linear statistical model includes computing the first score for the customer for the second dimension based on attribute values of the customer for the second dimension and at least on attribute values for the at least one other customer for the first dimension in the plurality of dimensions.

4. The method of claim 2, wherein the other pieces of data are attribute values in the second dimension for the at least one other customer.

5. The method of claim 2, wherein the computing the first score for the customer for the first dimension using the non-linear statistical model comprises:
generating a first modified set of attribute values and a second modified set of attribute values, wherein the first modified set of attribute values includes the attribute values of the customer for the first dimension and attribute values of a first customer in the at least one other customer for at least the second dimension in the plurality of dimensions and the second modified set of attribute values includes the attribute values of the customer for the first dimension and attribute values of a second customer in the at least one other customer for at least the second dimension in the plurality of dimensions;
computing a first plurality of probabilities of a plurality of possible outcomes using the non-linear statistical model and the first modified set of attribute values and computing a second plurality of probabilities of the plurality of possible outcomes using the non-linear statistical model and the second modified set of attribute values;
selecting a first possible outcome with the highest probability in the first plurality of probabilities and a second possible outcome with the highest probability in the second plurality of probabilities; and
calculating the mean of the highest probability in the first plurality of probabilities and the highest probability in the second plurality of probabilities, wherein the mean is the first score that indicates the influence of the first dimension on the predicted outcome for the customer.

6. The method of claim 5, wherein the first possible outcome and the second possible outcome are the same as the predicted outcome of the customer.

7. The method of claim 2, further comprising:
computing, by the computing device, for each dimension in the plurality of dimensions, a second score based on multiple applications of the non-linear statistical model on the different combinations of the other pieces of data with the attribute values of the customer in that dimension, wherein the second score for the customer for each of the plurality of dimensions indicates a health of that dimension for possible improvement; and
causing the presentation on the display of a representation of the second scores for the plurality of dimensions to the user to instruct the user in determining the course of action.

8. The method of claim 7, wherein the computing the second score for the customer for the first dimension using the non-linear statistical model comprises:
generating a first modified set of attribute values and a second modified set of attribute values, wherein the first modified set of attribute values includes the attribute values of the customer for the first dimension and attribute values of a first customer in the at least one other customer for at least the second dimension in the plurality of dimensions and the second modified set of attribute values includes the attribute values of the customer for the first dimension and attribute values of a second customer in the at least one other customer for at least the second dimension in the plurality of dimensions;
computing a first probability of a first possible outcome from a plurality of possible outcomes and a second probability of a second possible outcome from a plurality of possible outcomes using the non-linear statistical model and the first modified set of attribute values; and
computing a third probability of the first possible outcome and a fourth probability of the second possible outcome using the non-linear statistical model and the second modified set of attribute values,
wherein the plurality of possible outcomes are scaled from a best outcome to a worst outcome and the first possible outcome are the best outcome and the second possible outcome are the worst possible outcome.

8. The method of claim 7, wherein the best possible outcome is the strongest possible relationship with a company associated with the user and worst possible outcome is the weakest possible relationship with the company.

9. The method of claim 7, wherein the computing the second score for the customer for the first dimension using the non-linear statistical model further comprises:
calculating an average of the first probability and the third probability to generate a first average; and
calculating an average of the second probability and the fourth probability to generate a second average,
wherein the first average and the second average collectively represent the second score.

10. The method of claim 7, wherein the representation includes presenting the first score and the second score for each dimension in the plurality of dimensions for the customer.

11. The method of claim 7, wherein the first score and the second score for each dimension help the user identify areas requiring additional attention, research, observation, or manipulation, and
wherein the user is to address the dimension with the highest first score and the lowest second score when the course of action is to change the predicted outcome, if the selected dimension is capable of being influenced by the customer service manager.

12. A non-transitory machine-readable medium for determining the influence of attributes on a predicted outcome for an entity, wherein the predicted outcome was selected from a plurality of possible outcomes based on probabilities generated by application of a non-linear statistical model on a plurality of input attributes, wherein there is an attribute value for each of the plurality of attributes that describes a behavior or a characteristic of the entity to which the predicted outcome applied, wherein the non-transitory machine-readable medium stores instructions that when executed by a processor of an electronic device, cause the electronic device to:
compute for each dimension in a plurality of dimensions, a first score based on multiple applications of the non-linear statistical model on different combinations of other pieces of data with the attribute values for the customer in that dimension, wherein each attribute in the plurality of attributes was categorized into one of the plurality of dimensions based on a common characteristic chosen for that dimension, wherein each dimension in the plurality of dimensions includes two or more of the plurality of attributes, wherein all of the attributes in each dimension in the plurality of dimensions share the common characteristic chosen for that dimension, wherein each of the other pieces of data for each of the plurality of dimensions are attribute values independent of the dimension and the entity, wherein the first score for the entity for each of the plurality of dimensions indicates the influence of that dimension on the predicted outcome for the entity; and
cause the presentation on a display of a representation of the first scores for the plurality of dimensions to a user to instruct the user in determining a course of action.

13. The non-transitory machine-readable medium of claim 12, wherein the computing a first score for the entity for a first dimension in the plurality of dimensions using the non-linear statistical model includes computing the first score for the entity for the first dimension based on attribute values of the entity for the first dimension and at least on attribute values for at least one other entity for a second dimension in the plurality of dimensions.

14. The non-transitory machine-readable medium of claim 13, wherein one dimension of the plurality of dimensions includes attributes from at least two other dimensions of attributes.

15. The non-transitory machine-readable medium of claim 13, wherein the computing the first score for the entity for the first dimension using the non-linear statistical model comprises:
generating a first modified set of attribute values and a second modified set of attribute values, wherein the first modified set of attribute values includes the attribute values of the entity for the first dimension and attribute values of a first entity in the at least one other entity for at least the second dimension in the plurality of dimensions and the second modified set of attribute values includes the attribute values of the entity for the first dimension and attribute values of a second entity in the at least one other entity for at least the second dimension in the plurality of dimensions;
computing a first plurality of probabilities of a plurality of possible outcomes using the non-linear statistical model and the first modified set of attribute values and computing a second plurality of probabilities of the plurality of possible outcomes using the non-linear statistical model and the second modified set of attribute values;
selecting a first possible outcome with the highest probability in the first plurality of probabilities and a second possible outcome with the highest probability in the second plurality of probabilities; and
calculating the mean of the highest probability in the first plurality of probabilities and the highest probability in the second plurality of probabilities, wherein the mean is the first score that indicates the influence of the first dimension on the predicted outcome for the entity,
wherein the first possible outcome and the second possible outcome are the same as the predicted outcome of the entity.

16. The non-transitory machine-readable medium of claim 13, wherein the instruction when executed by the processor further cause the electronic device to
compute for each dimension in the plurality of dimensions, a second score based on multiple applications of the non-linear statistical model on the different combinations of the other pieces of data with the attribute values of the entity in that dimension, wherein the second score for the entity for each of the plurality of dimensions indicates a health of that dimension for possible improvement; and
cause the presentation on the display of a representation of the second scores for the plurality of dimensions to the user to instruct the user in determining the course of action.

17. The non-transitory machine-readable medium of claim 16, wherein the computing the second score for the entity for the first dimension using the non-linear statistical model comprises:
generating a first modified set of attribute values and a second modified set of attribute values, wherein the first modified set of attribute values includes the attribute values of the entity for the first dimension and attribute values of a first entity in the at least one other entity for at least the second dimension in the plurality of dimensions and the second modified set of attribute values includes the attribute values of the entity for the first dimension and attribute values of a second entity in the at least one other entity for at least the second dimension in the plurality of dimensions;
computing a first probability of a first possible outcome from a plurality of possible outcomes and a second probability of a second possible outcome from a plurality of possible outcomes using the non-linear statistical model and the first modified set of attribute values; and
computing a third probability of the first possible outcome and a fourth probability of the second possible outcome using the non-linear statistical model and the second modified set of attribute values,
wherein the plurality of possible outcomes are scaled from a best outcome to a worst outcome and the first possible outcome are the best outcome and the second possible outcome are the worst possible outcome.

18. A device for determining the influence of attributes on a predicted outcome for a customer, wherein the predicted outcome was selected from a plurality of possible outcomes based on probabilities generated by application of a non-linear statistical model on a plurality of input attributes, wherein there is an attribute value for each of the plurality of attributes that describes a behavior or a characteristic of the customer, the device comprising:
a categorizer to categorize each attribute in the plurality of attributes into one of a plurality of dimensions based on a common characteristic chosen for that dimension, wherein each dimension in the plurality of dimensions includes two or more of the plurality of attributes, wherein all of the attributes in each dimension in the plurality of dimensions share the common characteristic chosen for that dimension;
a non-linear statistical model to compute probabilities of each possible outcome in the plurality of possible outcomes;
a score generator for computing for each dimension in the plurality of dimensions, a first score based on multiple applications of the non-linear statistical model on different combinations of other pieces of data with the attribute values for the customer in that dimension, wherein each of the other pieces of data for each of the plurality of dimensions are attribute values independent of the dimension and the customer, wherein the first score for the customer for each of the plurality of dimensions indicates the influence of that dimension on the predicted outcome for the customer.

19. The device of claim 19, wherein the computing a first score by the score generator for the customer for a first dimension in the plurality of dimensions using the non-linear statistical model includes computing the first score for the customer for the first dimension based on attribute values of the customer for the first dimension and at least on attribute values for at least one other customer for a second dimension in the plurality of dimensions.

20. The device of claim 19, wherein the score generator is to further:
compute for each dimension in the plurality of dimensions, a second score based on multiple applications of the non-linear statistical model on the different combinations of the other pieces of data with the attribute values of the customer in that dimension, wherein the second score for the customer for each of the plurality of dimensions indicates a health of that dimension for possible improvement.
